(19) United States
(12) Patent Application Publication
(10) Pub. No.: US 2020/0179832 A1
(43) Pub. Date: Jun. 11, 2020

(54) FILTER CARTRIDGE

(71) Applicant: GLOBAL SPIRITS FILTRATION COMPANY, LLC, Mason City, IA (US)

(72) Inventor: Randy Wenthold, Menahga, MN (US)

(21) Appl. No.: 16/706,069

(22) Filed: Dec. 6, 2019

Related U.S. Application Data
(60) Provisional application No. 62/776,652, filed on Dec. 7, 2018.

(51) Int. Cl. B01D 27/08; B01D 35/30; B01D 27/04; B01D 39/20

(52) U.S. Cl. CPC B01D 27/08; B01D 35/30; B01D 2201/18; B01D 39/2034; C02F 2201/006; B01D 27/04

(57) ABSTRACT

A filter cartridge for use within a filter housing includes a filter tube, a flow port, and a filter plate. The filter tube can be formed of an elongated tubular member that is porous along its length. The flow port can be disposed at one end of the filter tube. The filter plate can be formed of a porous material disposed within the flow port. The filter tube and the filter plate may define a resin chamber for containing an adsorbent polymer resin.

### TECHNICAL FIELD

The present disclosure relates to purifying fluids. More specifically, the disclosure relates to systems and methods for removing particles and organic compounds from fluids.

### BACKGROUND

Purification of some fluids may require filtration to remove unwanted particles, as well as treatment to remove undesired organic compounds. For example, in the production of some beverages, organic compounds can be produced from the processing of various plant and plant-derived materials, such as fruits, tubers, grains, honey, and sugar cane. The processing may include fermentation and/or distillation, for example. The processing may result in some organic compounds which are desired for the beverage, such as ethanol, for example, and some organic compounds which are not desired as they may impart an undesired flavor texture and/or appearance The processing may also result in particulate matter in the beverage, which may also impart an undesired flavor, texture, and/or appearance. In some instances, it may be desirable to purify the beverage by removing some, or substantially all, of these undesired organic compounds and particles from the beverage.

### SUMMARY

Example 1 is a filter cartridge for use within a filter housing. The filter cartridge includes a filter tube, a flow port, and a filter plate The filter tube can be formed of an elongated tubular member that is porous along its length. The flow port can be disposed at an end of the filter tube. The filter plate can be formed of a porous material disposed within the flow port. The filter tube and the filter plate may define a resin chamber for containing an adsorbent polymer resin.

Example 2 is the filter cartridge of Example 1, further including a resin port disposed at another end of the filter tube opposite the flow port, the resin port including a removable plug.

Example 3 is the filter cartridge of either of Examples 1 or 2, wherein the filter tube forms a cylindrical shape.

Example 4 is the filter cartridge of any of Examples 1-3, wherein the filter tube is formed of a sintered metal.

Example 4 is the filter cartridge of any of Examples 1-4, wherein pores of the filter tube have an average pore diameter of 0.1 micron to 100 microns, as determined by capillary flow porometry.

Example 6 is the filter cartridge of any of Examples 1-5, wherein the filter plate is formed of a sintered metal.

Example 7 is the filter cartridge of any of Examples 1-6, wherein pores of the filter plate have an average pore diameter of 0.1 micron to 100 microns, as determined by capillary flow porometry.

Example 8 is the filter cartridge of any of Examples 1-7, further including an adsorbent polymer resin contained within the resin chamber.

Example 9 is the filter cartridge of Example 8, wherein the adsorbent polymer resin includes resin beads having an average diameter ranging from 25 microns to 1,500 microns.

Example 10 is a filter assembly including a filter housing and a filter cartridge. The filter cartridge is contained within the filter housing. The filter cartridge includes a filter tube a flow port, and a filter plate. The fill tube can be formed of an elongated tubular member that is porous along its length. The flow port can be disposed at an end of the filter tube. The filter plate can be formed of a porous material disposed within the flow port. The filter tube and the filter plate may define a resin chamber for containing an adsorbent polymer resin.

Example 11 is the filter assembly of Example 10, wherein the flow port is configured to be coupled to the filter housing.

Example 12 is the filter assembly of either of Examples 10 or 11, further including a resin port disposed at another end of the filter tube opposite the flow port, the resin port including a removable plug.

Example 13 is the filter assembly of any of Examples 10-12, wherein the filter tube forms a cylindrical shape.

Example 14 is the filter assembly of any of Examples 10-13, wherein the filter tube is formed of a sintered metal.

Example 15 is the filter assembly of any of Examples 10-14, wherein pores of the filter tube have an average pore diameter of 0.1 micron to 100 microns, as determined by capillary flow porometry.

Example 16 is the filter assembly of any of Examples 10-15, wherein the filter plate is formed of a sintered metal.

Example 17 is the filter assembly of any of Examples 10-16, wherein pores of the filter plate have an average pore diameter of 0.1 micron to 100 microns, as determined by capillary flow porometry.

Example 18 is the filter assembly of any of Examples 10-17, wherein the filter cartridge further includes an adsorbent polymer resin contained within the resin chamber.

Example 19 is the filter assembly of Example 18, wherein the adsorbent polymer resin includes resin beads having an average diameter ranging from 25 microns to 1,500 microns.

Example 20 is a method for purifying a fluid. The method includes flowing the fluid into a filter housing, filtering the fluid through pores of an elongated tubular member within the housing to remove particles from the fluid, the elongated tubular member being porous along its length, passing the filtered fluid through an adsorbent polymer resin contained within the elongated tubular member to adsorb materials from the fluid, filtering the fluid through pores of a filter plate to remove particles from the fluid, and flowing the filtered fluid out of the filter housing.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a side view of a filter cartridge, according to some embodiments of the disclosure.

FIG. 2 is an end view of the filter cartridge of FIG. 1 showing a flow port, according to some embodiments of this disclosure.

FIG. 3 is another end view of the filter cartridge of FIG. 1 showing a resin port, according to some embodiments of this disclosure.

FIG. 4 is a side cross-sectional view of the filter cartridge of FIG. 1, according to some embodiments of this disclosure.

FIG. 5 is a side cross-sectional view of a filter assembly, according to some embodiments of this disclosure.

### DETAILED DESCRIPTION

Purification of fluids to remove at least some undesired particles and at least some undesired organic compounds may be done with a series of filter and adsorption operations. For example, a vessel containing an adsorbent polymer resin can be used to adsorb some organic compounds from a distilled beverage stream, as described in co-pending U.S. provisional patent application No. 62/623,676, which is incorporated herein by reference in its entirety. In another example, porous metal filter elements can be used to filter particles from fluids flowing through the filter elements, such as those available from Mott Corporation, Farmington, Conn.

Embodiments of the present disclosure include filter cartridges that can both filter particles from a fluid and adsorb organic compounds from the fluid to purify the fluid. Purifying with a filter cartridge that does both may be more efficient than conducting separate operations, in terms of both space requirements and operational simplicity. The filter cartridges may also include two filter elements to provide two filtering steps to filter out a higher percentage of particles than a single filter step.

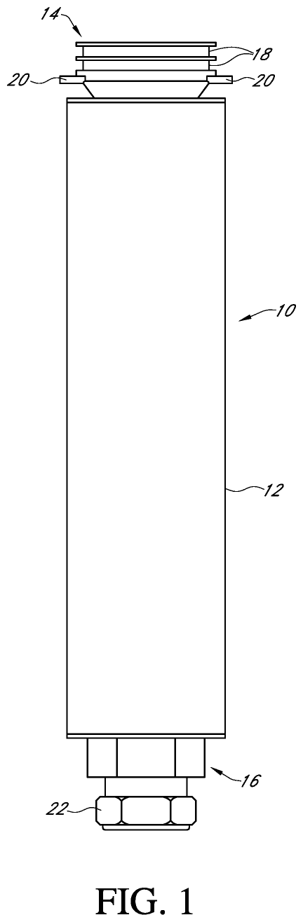

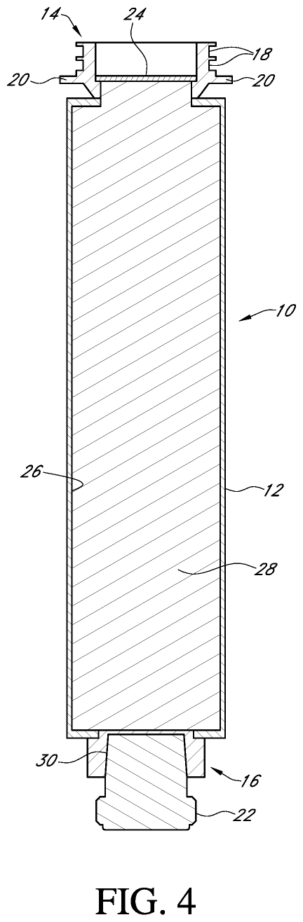

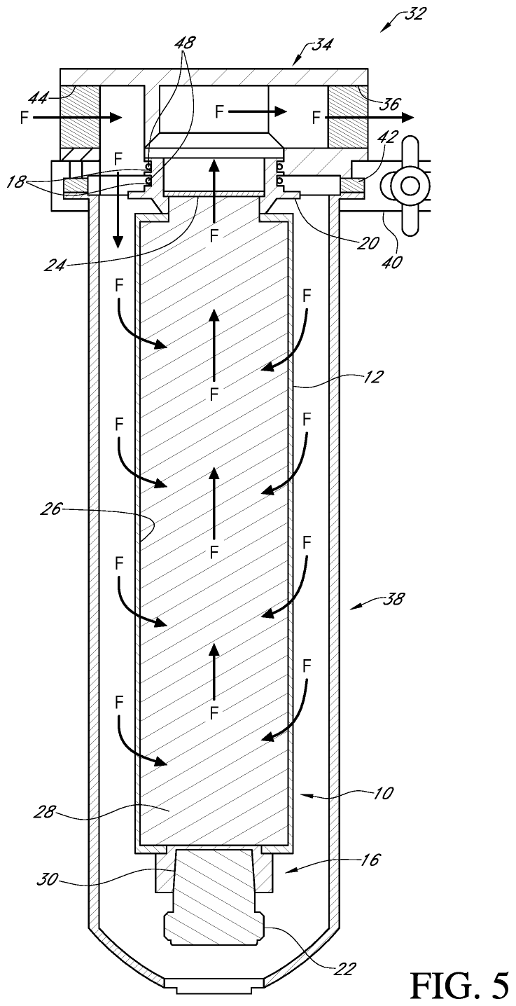

FIG. 1 is a side view of a filter cartridge, according to some embodiments of the disclosure FIG. 1 shows a filter cartridge 10 including a filter tube 12, a flow port 14, and a resin port 16. The flow port 14 can include fittings as desired for coupling to a filter housing, such as the filter housing 34 described below in reference to FIG. 5. In the embodiment shown in FIG. 1, the flow port 14 includes grooves 18 for a double O-ring seal and fins 20 for coupling the filter cartridge 10 to the filter housing 34 (FIG. 5). The resin port 16 can include a plug 22. The plug 22 may be removable, as described below in reference to FIG. 4. The plug 22 may be a hex plug. As shown in the embodiment of FIG. 1, the flow port 14 may be disposed at one end of the filter tube 12, and the resin port 16 may be disposed at an end of the filter tube 12 opposite the flow port 14.

The filter tube 12 is an elongated tubular member that is porous along its length. In some embodiments, the filter tube 12 is porous along its entire length. In some other embodiments, the filter tube 12 is porous along for as little as 20%, 30%, 40%, 50%, or 60%, or as much as 70%, 80%, 90%, or 99% of its length, or be within any range defined between any two of the foregoing values, such as 20% to 99%, 30% to 90%, 40% to 80%, 50% to 70%, 50% to 99%, or 80% to 90%, for example.

An average pore diameter of pores that provide the porosity for the filter tube 12 may be as small as 0.1 micron, 0.2 microns, 0.5 microns, 1 micron, or 2 microns, or be as large as 5 microns, 10 microns, 20 microns, 50 microns, or 100 microns, or be within any range defined between any two of the foregoing values, such as 0.1 micron to 100 microns, 0.2 microns to 50 microns, 0.5 microns to 20 microns, 1 micron to 10 microns, 2 microns to 5 microns, or 0.2 microns to 2 microns, for example. The average pore diameter may be determined by capillary flow porometry as described in ASTM F316-03(2011).

In some embodiments, the filter tube 12 may be formed of a sintered metal. The sintered metal may include stainless steel (types 304L, 310, 316L, 347 or 430, for example), nickel-chromium alloy (Inconel® 600, 625 or 690, for example), nickel-molybdenum-chromium alloy (Hastelloy® B, B-2, C-22, C276, N or X, for example), nickel-copper alloy (Monel® 400, for example), nickel-iron-chromiuni alloy (alloy 20, for example), nickel (Nickel 200, for example), titanium, or combinations thereof. In some other embodiments, the filter tube 12 may be formed of a porous polymer, such as polypropylene, polyethylene, polyvinylidene fluoride, polytetrafluoroethyIene, ethyl vinyl acetate, polycarbonate, nylon 6, thermoplastic polyurethane, polyethersulfone, or combinations thereof.

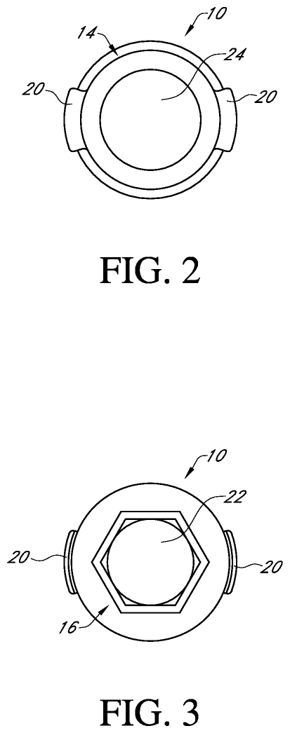

FIG. 2 is an end view of the filter cartridge 10 of FIG. 1 showing the flow port 14, according to some embodiments of this disclosure. As shown in FIG. 2, the filter cartridge 10 can further include a filter plate 24 disposed within the flow port 14. The filter plate 24 can be formed of a porous material.

An average pore diameter of pores that provide the porosity for the filter plate 24 may be as small as 0.1 micron, 0.2 microns, 0.5 microns, 1 micron, or 2 microns, or be as large as 5 microns, 10 microns, 20 microns, 50 microns, or 100 microns, or be within any range defined between any two of the foregoing values, such as 0.1 micron to 100 microns, 0.2 microns to 50 microns, 0.5 microns to 20 microns, 1 micron to 10 microns, 2 microns to 5 microns, or 0.2 microns to 2 microns, for example. The average pore diameter may be determined by capillary flow porometry as described in ASTM F316-03(2011).

In some embodiments, the average pore diameter of pores that provide the porosity for the filter plate 24 may be substantially same as the average pore diameter of pores that provide the porosity for the filter tube 12. In other embodiments, the average pore diameter of pores that provide the porosity for the filter plate 24 may be larger than the average pore diameter of pores that provide the porosity for the filter tube 12. In still other embodiments, the average pore diameter of pores that provide the porosity for the filter plate 24 may be smaller than the average pore diameter of pores that provide the porosity for the filter tube 12.

In some embodiments, the filter plate 24 may be formed of a sintered metal. The sintered metal may include stainless steel (types 304L, 310, 316L, 347 or 430, for example), nickel-chromium alloy (Inconel® 600, 625 or 690, for example), nickel-molybdenum-chromium alloy (Hastelloy® B, B-2, C-22, C276, N or X, for example), nickel-copper alloy (Monel® 400, for example), nickel-iron-chromium alloy (Alloy 20, for example), nickel (Nickel 200, for example), titanium, or combinations thereof. In some other embodiments, the filter plate 24 may be formed of a porous polymer, such as polypropylene, polyethylene, polyvinylidene fluoride, polytetrafluoroethylene, ethyl vinyl acetate, polycarbonate, nylon 6, thermoplastic polyurethane, polyethersulfone, or combinations thereof.

In some embodiments, the flow port 14 may be formed of a metal including stainless steel (types 304L, 310, 316L, 347 or 430, for example), nickel-chromium alloy (Inconel® 600, 625 or 690, for example), nickel-molybdenum-chromium alloy (Hastelloy® B, B-2, C-22, C276, N or X, for example), nickel-copper alloy (Monel®400, for example), nickel-iron-chromium alloy (Alloy 20, for example), nickel (Nickel 200, for example), titanium, or combinations thereof. In some other embodiments, the flow port 14 may be formed of a polymer, such as polypropylene, polyethylene, polyvinylidene fluoride, polytetrafluoroethylene, ethyl vinyl acetate, polycarbonate, nylon 6, thermoplastic polyurethane, polyethersulfone, or combinations thereof.

FIG. 3 is another end view of the filter cartridge 10 of FIG. 1 showing the resin port 16, according to some embodiments of this disclosure. In some embodiments, the resin port 16 may be formed of a metal including stainless steel (types 304L, 310, 316L, 347 or 430, for example), nickel-chromium alloy (Inconel® 600, 625 or 690, for example), nickel-molybdenum-chromium alloy (Hastelloy® B, B-2, C-22, C276, N or X, for example), nickel-copper alloy (Monel® 400, for example), nickel-iron-chromium alloy (Alloy 20, for example), nickel (Nickel 200, for example), titanium, or combinations thereof. In some other embodiments, the resin port 16 may be formed of a polymer, such as polypropylene, polyethylene, polyvinylidene fluoride, polytetrafluoroethylene, ethyl vinyl acetate, polycarbonate, nylon 6, thermoplastic polyurethane, polyethersulfone, or combinations thereof.

Considering FIGS. 1-3 together, in some embodiments, the filter tube 12, the flow port 14, the resin port 16, and the filter plate 24 may be welded together such that the filter cartridge 10 is strong, durable, and reliably free of leaks. An all-welded construction may be particularly important in applications involving the purification of corrosive fluids which could attack joints involving other materials, such as adhesives. In the embodiment of FIGS. 1-3, the filter tube 12 is shown as cylindrical, with a circular cross-section. In other embodiments, the filter tube 12 may have a non-circular cross-section, such as an ellipse, or a regular convex polygon, such as a triangle, a parallelogram, a pentagon, a hexagon, or an octagon, for example.

FIG. 4 is a side cross-sectional view of the filter cartridge 10 of FIG. 1, according to some embodiments of this disclosure. As shown in FIG. 4, the filter tube 12 and the filter plate 24 define a resin chamber 26 for containing an adsorbent polymer resin 28. In some embodiments, the filter cartridge 10 further includes the adsorbent polymer resin 28, as shown in FIG. 4.

In some embodiments, the adsorbent polymer resin 28 can be in the form of a plurality of spherical beads. The cross-linked structure can provide the spherical beads of the adsorbent polymer resin 28 with high crush strength to maintain open fluid paths through the adsorbent polymer resin 28.

In some embodiments, beads of the adsorbent polymer resin 28 may have an average diameter as small as 25 microns, 40 microns, 60 microns. 80 microns. 100 microns or 200 microns, or be as large as 400 microns, 600 microns, 800 microns, 1,000 microns, 1,200 microns or 1,500 microns, or be within any range defined between any two of the foregoing values, such as 25 microns to 1,500 microns, 40 microns to 1,200 microns, 60 microns to 1,000 microns, 80 micron to 800 microns, 100 microns to 600 microns, 200 microns to 400 microns, or 800 microns to 1,200 microns, for example. Average bead diameters may be determined by flow cytometry, as is known in the art.

The adsorbent polymer resin 28 can be a hydrophobic resin. In some embodiments, the adsorbent polymer resin 28 can be substantially non-functionalized. That is, a surface of the adsorbent polymer resin 28 is substantially free of functional groups grafted, or covalently bonded, to surface of the adsorbent polymer resin 28. For applications involving the purification of an ethanol-containing fluid, for example, it is believed that the hydrophobic nature of the surface of the adsorbent polymer resin 28 reduces the adsorption of ethanol compared with polymer resins that are hydrophilic, or polymer resins that are hydrophobic but have hydrophilic functional groups grafted to their surfaces.

In some embodiments, the adsorbent polymer resin 28 can be macroporous. A macroporous resin, also referred to as a macroreticular resin, can have a porous or multi-channel structure to provide a large surface area per gram of resin. For example, in some embodiments, the adsorbent polymer resin 28 can have a Brunauer, Emmett and Teller (BET) surface area greater than 700 m²/g. In some embodiments, the adsorbent polymer resin 28 can have a BET surface area greater than 1,100 m²/g.

In some embodiments, the adsorbent polymer resin 28 can include a polystyrene divinylbenzene polymer. In some embodiments, the adsorbent polymer resin 28 can be a styrenic polymer cross-linked with divinylbenzene. In some embodiments, the adsorbent polymer resin 28 can include Dowex™ Optipore™ L493 adsorbent resin, from the Dow Chemical Company, Midland, Mich. In some embodiments, the adsorbent polymer resin 28 can consist essentially of Dowex™ Optipore™ L493 adsorbent resin. In some embodiments, the adsorbent polymer resin 28 can consist of Dowex™ Optipore™ L493 adsorbent resin. In some embodiments, the adsorbent polymer resin 28 can include Amberlite™ FPX66 adsorbent resin, also from the Dow Chemical Company, Midland, Mich. In some embodiments, the adsorbent polymer resin 28 can consist essentially of Amberlite™ FPX66 adsorbent resin. In some embodiments, the adsorbent polymer resin 28 can consist of Amberlite™ FPX66 adsorbent resin. In some embodiments, the adsorbent polymer resin 28 can include a combination of any of the previously mentioned adsorbent resins. It is understood that the adsorbent polymer resin 28 may include any absorbent polymer resin suitable to a particular application of the filter cartridge 10.

The plug 22 may include threads 30 that engage corresponding threads in the resin port 16 such that plug 22 may be removable. In other embodiments, the plug 22 may include other features instead of, or in addition to, threads 30 for engaging the resin port 16, such as fins similar to the fins 20 for coupling the plug 22 to the resin port 16. When the plug 22 is disengaged from the resin port 16 to open the resin port 16, the adsorbent polymer resin 28 may be added to, or removed from, the resin chamber 26 through the resin port 16. For example, the removeable plug 22 may be disengaged from the resin port 16, the adsorbent polymer resin 28 added to the resin chamber 26 through the resin port 16, and the plug 22 re-engaged with the resin port 16 to retain the adsorbent polymer resin 28 within the resin chamber 26 and seal the resin port 16 to substantially limit subsequent leakage of fluid through the resin port 16 when in use.

In another example, when the adsorbent polymer resin 28 is spent, the removeable plug 22 may be disengaged from the resin port 16, the spent adsorbent polymer resin 28 removed from the resin chamber 26 through the resin port 16, fresh adsorbent polymer resin 28 added to the resin chamber 26 through the resin port 16, and the plug 22 re-engaged with the resin port 16 to retain the fresh adsorbent polymer resin 28 within the resin chamber 26 and seal the resin port 16 In this way, the filter cartridge 10 may continue to be used, even after the adsorbent polymer resin 28 is spent, for efficient utilization of the filter cartridge 10.

In the embodiment shown in FIG. 4, the resin chamber 26 is shown substantially filled with beads of the adsorbent polymer resin 28. As used herein, substantially filled means the volume of the resin chamber 26 is filled with beads of the adsorbent polymer resin 28 without compressing the beads, thus leaving interstitial spaces between contacting beads intact for the efficient flow of fluid through the resin chamber 26. In other embodiments, the volume of the resin chamber 26 may be filled as little as 20%, 30%, 40%, or 50% or as much as 70%, 80%, 90%, or 95%, or be within any range defined between any two of the foregoing values, such as 20% to 95%, 30% to 90%, 40% to 80%, 50% to 70%, or 90% to 95%, for example.

FIG. 5 is a side cross-sectional view of a filter assembly, according to some embodiments of this disclosure. FIG. 5 show a filter assembly 32 including a filter housing 34 and the filter cartridge 10 contained within the filter housing 34. The filter housing 34 may be of a conventional type, and include a head 36, a body 38, and a clamp 40. The clamp 40 may couple the body 38 to the head 36 with a clamp gasket 42 to substantially prevent leakage from between the head 36 and the body 38. The head 36 may include an inlet 44 and an outlet 46. In some embodiments, the body 38 may include a drain plug (not shown) opposite the head 36. The flow port 14 of the filter cartridge 10 may be inserted into the head 36 as shown, with the fins 20 engaging corresponding features in the head 36 to couple the flow port 14 to the filter housing 34. Two O-rings 48 disposed within the grooves 18 may provide the double O-ring seal between the filter cartridge 10 and the head 36.

Although filter cartridge 10 is shown with the flow port 14 including a double O-ring seal and fins 20 for coupling the filter cartridge 10 to the filter housing 34, it is understood that embodiments may include any alternative mechanisms for coupling a filter cartridge to a filter housing. Thus, embodiments may be used as a drop-in replacement in any conventional filter housing with a compatible coupling interface. Alternative coupling mechanisms known in the art include threaded couplings and sanitary couplings, for example.

In use, a flow F of fluid to be purified of particles and materials, such as undesired organic compounds, may enter the filter housing 34 through the inlet 44 of the head 36. The flow F can pass from the head 36 into the body 38, pressurizing the volume of the body 38 surrounding the filter tube 12. The pressure can force the flow F through the pores of the filter tube 12 and into the resin chamber 26, trapping at least some of the particles of the flow F on the surface of, and within the pores of, the filter tube 12 to filter out the particles. Once in the resin chamber 26, the flow F passes through the adsorbent polymer resin 28 contained within the resin chamber 26. The adsorbent polymer resin 28 adsorbs materials from the flow F as it passes through the resin chamber 26, such as at least some of the undesired organic compounds are removed from the flow F. The flow F then passes through the pores of the filter plate 24, trapping at least some additional particles of the flow F on the surface of, and within the pores of the filter plate 24. The flow F passes out of the filter housing 34 through the outlet 46 as a purified flow of fluid.

In use, the pressure across the filter assembly 32 may be as low as 0.1 psig (0.7 kPa), 0.2 psig (1.4 kPa), 0.5 psig (3.5 kPa), 1 psig (6.9 kPa), 2 psig (13.8 kPa), or 5 psig (34.5 kPa), or as high as 10 psig (69 kPa), 20 psig (138 kPa), 50 psig (345 kPa), 100 psig (690 kPa), 200 psig (1,379 kPa), or 500 psig (3,447 kPa), or be within any range defined between any two of the foregoing values, such as 0.1 psig to 500 psig, 0.2 psig to 200 psig, 0.5 psig to 100 psig, 1 psig to 50 psig, 2 psig to 20 psig, 5 psig to 10 psig, 0.1 psig to 100 psig, or 100 psig to 500 psig, for example.

The temperature of the flow F may be as low as 33° F. (0.6° C.), 40° F. (4.4° C.), 50° F. (10° C.), 60° F. (16° C.), 75° F. (24° C.), or 90° F. (32° C.), or as high as 115° F. (46° C.), 140° F. (60° C.), 170° F. (77° C.), 210° F. (99° C.), 260° F. (127° C.), or 320° F. (160° C.), or be within any range defined between any two of the foregoing values, such as 33° F. to 320° F., 40° F. to 260° F., 50° F. to 210° F., 60° F. to 170° F., 75° F. to 140° F., 90° F. to 115° F., 33° F. to 50° F., or 210° F. to 320° F., for example.

After some period of use, the filter cartridge 10 may need to be regenerated to remove trapped particles and adsorbed organic compounds, this may be accomplished by back-flushing through the filter assembly 32 with a fluid able to desorb the adsorbed organic compounds and/or dislodge napped particles. In some embodiments, the fluid can include steam. In some embodiments, the fluid can include a sodium hydroxide solution. It is understood that the fluid may include any fluid suitable for regeneration of the adsorbent polymer resin 28 as recommended by the resin manufacturer.

After multiple regenerations, the adsorbent polymer resin 28 may no longer adsorb adequately after regeneration and is spent. The spend adsorbent polymer resin 28 may be removed and replaced as described above in reference to FIG. 4.

Alternatively, in some embodiments, the flow F of fluid to be purified of particles and materials may be reversed, with particles initially filtered out of the flow F with the filter plate 24, passing through the adsorbent polymer resin 28 in the resin chamber 26, and the being filtered again through the filter tube 12.

Filter cartridges according to embodiments of the disclosure, such as filter cartridge 10, substantially eliminate channeling in the adsorbent polymer resin 28 due at least in part to the flow F passing through the pores of the filter tube 12 along the length of the filter tube 12, thus entering the resin chamber 26 at many locations.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A filter cartridge for use within a filter housing, the filter cartridge comprising:
a filter tube formed of an elongated tubular member that is porous along its length;
a flow port disposed at an end of the filter tube;
a filter plate formed of a porous material disposed within the flow port, the filter tube and the filter plate defining a resin chamber for containing an adsorbent polymer resin.

2. The filter cartridge of claim 1, further including a resin port disposed at another end of the filter tube opposite the flow port, the resin port including a removable plug.

3. The filter cartridge of claim 1, wherein the filter tube forms a cylindrical shape.

4. The filter cartridge of claim 1, wherein the filter tube is formed of a sintered metal.

5. The filter cartridge of claim 1, wherein pores of the filter tube have an average pore diameter of 0.1 micron to 100 microns, as determined by capillary flow porometry.

6. The filter cartridge of claim 1, wherein the filter plate is formed of a sintered metal.

7. The filter cartridge of claim 1, wherein pores of the filter plate have an average pore diameter of 0.1 micron to 100 microns, as determined by capillary flow porometry.

8. The filter cartridge of claim 1, further including an adsorbent polymer resin contained within the resin chamber.

9. The filter cartridge of claim 8, wherein the adsorbent polymer resin includes resin beads having an average diameter ranging from 25 microns to 1,500 microns.

10. A filter assembly comprising:
a filter housing; and
a filter cartridge contained within the filter housing, the filter cartridge including:
a filter tube formed of an elongated tubular member that is porous along its length;
a flow port disposed at an end of the filter tube;
a filter plate formed of a porous material disposed within the flow port, the filter tube and die filter plate defining a resin chamber for containing an adsorbent polymer resin.

11. The filter assembly of claim 10, wherein the flow port is configured to be coupled to the filter housing.

12. The filter assembly of claim 10, further including a resin port disposed at another end of the filter tube opposite the flow port, the resin port including a removable plug.

13. The filter assembly of claim 10, wherein the filter tube forms a cylindrical shape.

14. The filter assembly of claim 10, wherein the filter tube is formed of a sintered metal.

15. The filter assembly of claim 10, wherein pores of the filter tube have an average pore diameter of 0.1 micron to 100 microns, as determined by capillary flow porometry.

16. The filter assembly of claim 10, wherein the filter plate is formed of a sintered metal.

17. The filter assembly of claim 10, wherein pores of the filter plate have an average pore diameter of 0.1 micron to 100 microns, as determined by capillary flow porometry.

18. The filter assembly of claim 10, wherein the filter cartridge further includes an adsorbent polymer resin contained within the resin chamber.

19. The filter assembly of claim 18, wherein the adsorbent polymer resin includes resin beads having an average diameter ranging from 25 microns to 1,500 microns.

20. A method for purifying a fluid, the method comprising:
flowing the fluid into a filter housing;
filtering the fluid through pores of an elongated tubular member within the housing to remove particles from the fluid, the elongated tubular member being porous along its length;
passing the filtered fluid through an adsorbent polymer resin contained within the elongated tubular member to adsorb materials from the fluid;
filtering the fluid through pores of a filter plate to remove particles from the fluid, and
flowing the filtered fluid out of the filter housing.
